(19) United States
(12) Patent Application Publication
(10) Pub. No.: US 2003/0195284 A1
(43) Pub. Date: Oct. 16, 2003

(54) Low bio-burden elastic bandage

(76) Inventors: Syng L. Paik, Johnson City, TN (US); Robert A. Wimberly, Milligan College, TN (US); Matthew T. Hafner, Bluff City, TN (US); Steven G. McDonald, Johnson City, TN (US)

Correspondence Address: LUEDEKA, NEELY & GRAHAM, P.C., P O BOX 1871, KNOXVILLE, TN, 37901, US

(21) Appl. No.: 10/063,313

(22) Filed: Apr. 10, 2002

(51) Int. Cl. C08K 3/26; C08K 3/34

(52) U.S. Cl. 524/425; 524/442; 524/492

(57) ABSTRACT

A method for making an essentially natural rubber latex-free elastic compression bandage. The method includes providing a homogeneous mixture containing from about 20 to about 90 parts by weight synthetic natural rubber, from about 10 to about 80 parts by weight secondary elastomeric compound, fillers and processing aids. The mixture is fed to an extruder to provide an extruded web. The extruded web is calendered to provide a calendered web, and the calendered web is electron beam cured to provide an elastic web having a reduced bio-burden. The reduced bio-burden of the web enables production of bandages without prolonged sterilization techniques.

### BACKGROUND OF INVENTION

The invention relates to sterile elastic bandages for use as compression bandages for medical procedures and applications and improved methods for making the bandages.

Elastic compression bandages are used for a wide variety of medical and orthopedic purposes. One important use of elastic compression bandages is to deliver consistent pressure to extremities for exsanguination prior to surgery. While elastic bandages may be made from a variety of natural and synthetic materials, many patients are sensitive to products containing natural rubber latex components. Accordingly, there is a need for improved natural rubber latex-free elastic bandages.

Conventional processes for making elastic compression bandages require prolonged pre-treatment sterilization procedures to reduce the bio-burden of the bandages particularly when using the bandages in a sterile environment such as in an operating room. Another problem with conventional elastic compression bandages is that the talc used to prevent the bandage material from sticking to itself may cause dusting problems and makes sterilization more difficult and/or less effective.

Hence, there is a need for improved elastic compression bandages and improved methods for making the bandages.

### SUMMARY OF INVENTION

With regard to the above and other objects and advantages, the invention provides a method for making an essentially natural rubber latex-free elastic compression bandage. The method includes providing a homogenous mixture containing from about 20 to about 90 parts by weight synthetic natural rubber, from about 10 to about 80 parts by weight secondary elastomeric compound, fillers, and processing aids. The mixture is fed to an extruder to provide an extruded web. The extruded web is calendered to provide a calendered web, and the calendered web is electron beam cured to provide an elastic web having a reduced bio-burden.

An advantage of the invention is that an elastic compression bandage which is essentially natural rubber latex-free may be provided by a curing process which alone reduces the bio-burden of the bandage without the need for prolonged pre-treatment sterilization processes, such as cobalt 60 radiation treatment. The bio-burden of the bandages is an indication of the ability that the bandage has to support undesirable biological activity and may also be an indication to what extent the bandage is sterile. Pre-treatment sterilization processes using cobalt 60 radiation are typically conducted batch-wise in a concrete-shielded room wherein the items to be treated travel around both sides of a rack containing cobalt 60 for two to ten hours or more.

Another advantage of the invention is that the elastic bandage may be made with a reduced amount of free dust adhered thereto or substantially dust free.

Compared to conventional rubber vulcanization curing processes, the electron beam curing process of the invention is a significantly more efficient curing method for elastomeric compounds. Electron beam curing enables a more efficient use of curing energy and enables the manufacturing process for the compression bandages to be conducted on a substantially continuous basis thereby reducing manufacturing costs.

### BRIEF DESCRIPTION OF DRAWINGS

Further advantages of the invention will become apparent by reference to the detailed description of preferred embodiments when considered in conjunction with the drawings, which are not to scale, wherein like reference characters designate like or similar elements throughout the several drawings as follows:

FIG. 1 is a block flow diagram of a process for making an elastic bandage according to the invention; and

FIG. 2 is a process flow diagram for a method for making an elastic bandage according to the invention.

### DETAILED DESCRIPTION

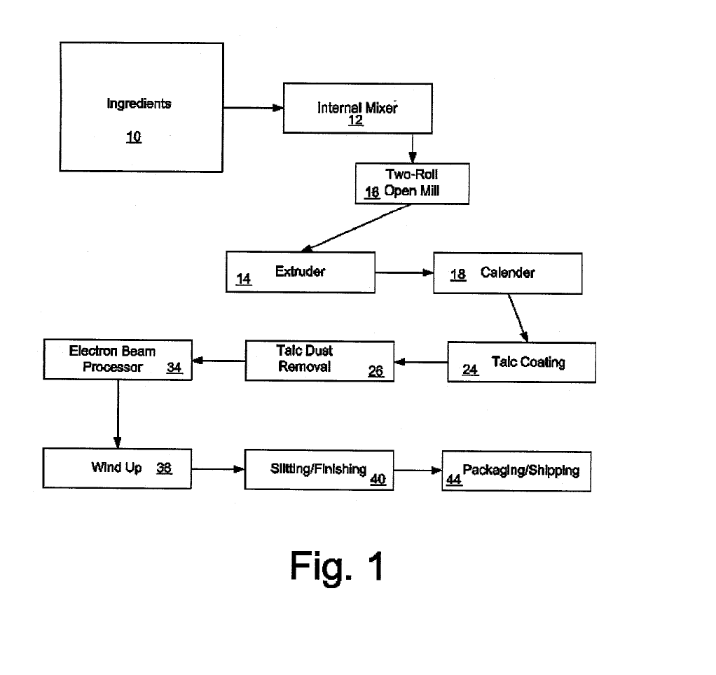

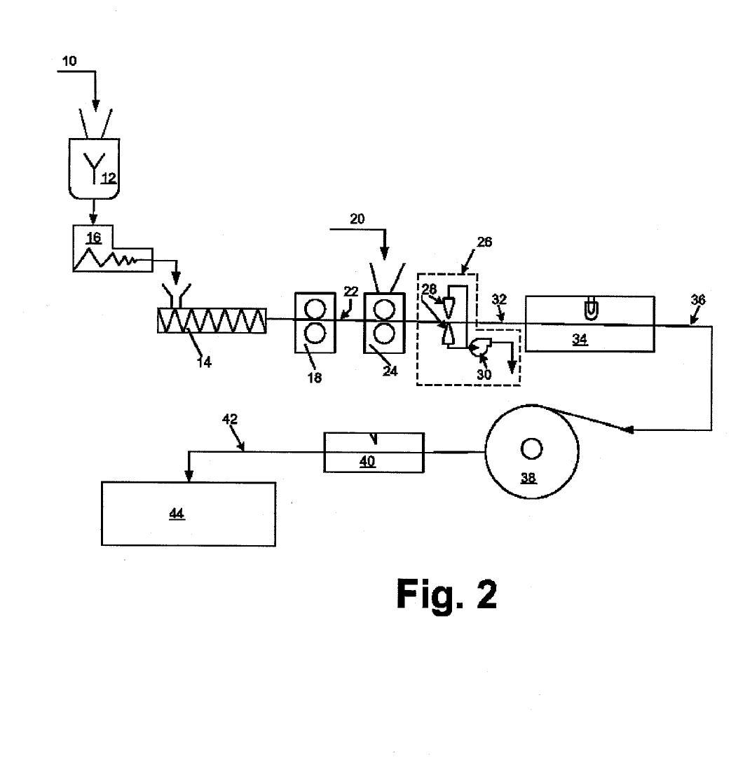

With reference now to FIGS. 1 and 2 a process for making elastic bandages according to the invention will now be described. According to the process, ingredients 10 for making the elastic bandages according to the invention preferably include a synthetic natural rubber, a secondary elastomeric compound, inorganic fillers, processing aids, colorants, antioxidants, and optional cure promoters. These ingredients 10 are provided to a mixer 12 to provide a substantially homogeneous mixture for feed to an extruder. The synthetic natural rubber is preferably synthetic polyisoprene, more preferably a solution polymerized high cis-1,4-polyisoprene stabilized with a non-staining antioxidant available from Goodyear Chemical Company of Akron, Ohio under the trade name NATSYN 2205. NATSYN 2205 synthetic rubber is substantially devoid of latex rubber components, has a low gel content, a light cream color and a Mooney Viscosity ML 1+4 at 100° C. of about 80. The amount of synthetic natural rubber present in the mixture preferably ranges from about 10 to about 70 percent by weight based on the total weight of components in the mixture. Other synthetic rubbers may be used, including but not limited to, acetylenic or ethylenic unsaturated polymers and copolymers such as polyethylene, polypropylene, polybutylene, polybutadiene, polyvinylacetate, polyvinylchloride, polyvinylidenechloride, ethylene-propylene copolymers, butadiene-styrene copolymers, butadiene-isoprene copolymers, isobutylene copolymers with isoprene, dicyclopentadiene, styrene divinylbenzene and the like.

Another preferred ingredient for making elastic bandages according to the invention is a secondary elastomeric compound. The secondary elastomeric compound may be selected from elastomeric polymers and copolymers which are substantially devoid of natural latex rubber ingredients. A particularly preferred elastomeric compound is styrene-butadiene rubber (SBR) copolymer available from DSM Copolymer, Inc. of Baton Rouge, La. under the trade name COPO 1502. COPO 1502 elastomeric compound has a Mooney Viscosity ML-4 at 100° C. ranging from about 65 to about 75, a light amber color, and a volatiles content by weight at 100° C. of about 0.75. The secondary elastomeric compound is preferably present in the elastic bandage mixture in an amount ranging from about 5 to about 60 percent by weight based on the total weight of the mixture. Other secondary elastomeric compounds may be used.

Prior to mixing the secondary elastomeric compound with the synthetic natural rubber compound, it is preferred to pre-masticate the secondary elastomeric compound in order to reduce the viscosity of the elastomeric compound for easier mixing with the synthetic natural rubber and other ingredients. The secondary elastomeric compound may be pre-masticated in a water-cooled internal mixer for about 15 minutes, depending on the batch size. Methods for pre-masticating an elastomeric compound are known to those skilled in the art.

The synthetic natural rubber and secondary elastomeric compound are preferably added to the mixer 12, such as a water-cooled Banbury internal mixer (Banbury Model Number 11). Then the other components including the inorganic filler, colorants, processing aids, antioxidant, and the like are added to the mixer 12. The ingredients 10 are mixed for a period of time ranging from about 5 to about 15 minutes or more depending on the batch size, at temperatures ranging from about 200° to about 350° F. It is preferred that the temperature and mixing time be controlled in the mixer 12 to prevent decomposition of the mixed ingredients as the mixing operation generates a significant amount of heat. Batch sizes in the heated mixer 12 may vary within wide limits and are preferably in the range of from about 300 to about 500 pounds.

The inorganic filler component of the ingredients 10 is preferably selected from the group consisting of silicon dioxide and carbonates and silicates of magnesium, calcium, aluminum, and zinc. A particularly preferred inorganic component is calcium carbonate which is preferably present in the ingredients 10 in an amount ranging from about 15 to about 35 percent by weight based on the total weight of the ingredients 10. Calcium carbonate is available from Harwick Standard Distribution Corporation of Akron, Ohio under the trade name STANWHITE UF-1.

Another preferred inorganic component is silicon dioxide, preferably a precipitated silicon dioxide. The preferred silicon dioxide component is available from PPG Industries of Pittsburgh, Pa. under the trade name HI-SIL WB-10. Aluminum silicates, such as kaolin clay may also be used. Kaolin clay is available from W. R. Grace & Company of Columbia, Md. as a fine off-white powder having a bulk density ranging from about 25 to about 27 pounds per cubic foot. When kaolin clay is used as one of the ingredients, it may be present in an amount ranging from about 0 to about 60 parts per hundred parts by weight rubber (phr).

Colorants which may be used to provide colored bandages include dyes and pigments which are compatible with the components of the mixture used to make the bandages. Preferred colorants include pigments which are preferably pre-mixed with synthetic rubbers such as SBR copolymers and ethylene-propylene rubber (EPR) copolymers. Particularly preferred colorants include metal oxide pigments such as titanium dioxide pigments and phthalocyanine-based pigments. Pigment white 6 is a titanium dioxide pigment available as a dispersion in EPR from Akrochem Corporation of Akron, Ohio under the trade name AKROSPERSE E-18016 White EPMB. Pigment green 7 is a phthalocyanine-based pigment available as a dispersion in SBR from Akrochem Corporation under the trade name AKROSPERSE 414 Green MB.

Other components of the ingredients 10 may include a re-odorant such as available from Harwick Standard Distribution Corporation under the trade name STAN-MASK 25243 vanilla, antioxidants such as butylated reaction products of p-cresol and dicyclopentadiene available from Goodyear Chemical Company of Beaumont, Tex. under the trade name WINGSTAY L HLS Powder, processing oils such as solvent refined heavy paraffinic petroleum oil available from Sunoco, Inc. of Philadelphia, Pa. under the trade name SUNPAR 150 and mineral oils such as available from Amco Chemical Corporation of Oakland, Calif. under the trade name PETROLATUM SR-172, and functional monomers for enhancing polymerization or cross-linking of the rubber components including acrylates and methacrylates such as trimethylolpropane triacrylate and trimethylolpropane trimethacrylate available from Sartomer of Exton, Pa. under the trade names SR-351 AND SR-350, respectively. When a functional monomer is used as a component of the ingredients, the functional monomer may be present in an amount ranging from about 0 to about 5 parts per hundred parts by weight rubber (phr). Conventional rubber processing procedures are preferably used for compounding the ingredients in the mixer 12. The ingredients 10 are preferably devoid of natural rubber latex compounds and vulcanization compounds such as sulfur.

The mixed ingredients may be fed directly to an extruder 14, or in the preferred alternative, to an open mill such as a two-roll open mill 16 for feed to the extruder 14. The open mill 16 provides for cross-cutting and folding back slabs of the mixed ingredients in order to provide an essentially smooth mixture. The mixed ingredients are then sheeted out for feed to the extruder 14. The open mill 16 is preferably maintained at a temperature ranging from about 100° to about 150° F. for feed to the extruder 14. The sheeted out slabs of mixed ingredients from the open mill are preferably rolled into individual bales each having a batch size ranging from about 20 to about 50 pounds or more to be used as feed stock to the extruder 14.

Once a substantially homogeneous mixture of the ingredients is provided, the mixture is preferably extruded in extruder 14 having a screw temperature ranging from about 100° to about 150° F. and a head temperature ranging from about 130° to about 190° F. The extrusion speed is related to the calendaring speed which is described below. Conventional roller conveyors or any other conventional conveying devices known to those skilled in the art may be used to transport sheets of extrudate from the extruder 14 to the calender rolls 18. A small rolling bank of extrudate may be formed at the nip of the calender rolls 18, however this rolling bank of extrudate is preferably minimized or eliminated.

The calender rolls 18 may be heated or cooled depending on the viscosity of the extrudate fed to the calender rolls 18. Throughput through the calender rolls 18 will vary depending on the desired width and thickness of the elastomeric bandage web to be made and the capacity of the electron beam curing device to cure the bandage material. Accordingly, the throughput of material through the calender rolls may range from about 500 to about 2500 pounds per hour for 10 to 30 inches by 10 to 30 mil thick sheets of elastomeric material to be cross-linked or cured. The linear speed of the web provided bys the calender rolls 18 may range from about 30 to about 180 feet per minute or more.

Subsequent to calendering, the calendered web 22 is optionally treated with a release agent such as hydrous magnesium silicate or talc 20 to reduce the tackiness of the uncured and cured web. A preferred hydrous magnesium silicate powder is available from Imifabi (Diana) LLC of Natural Bridge, N.Y. under the trade name talc USP BC 3355. Talc 20 may be applied to the calendered web by a variety of techniques including, but not limited to, coated rolls 24 which are in direct contact with both surfaces of the calendered web 22. Excess talc 20 is preferably removed from the calendered web 22 after the release agent application process by dusting, vacuuming or a combination thereof. As shown in FIG. 2, a vacuum system 26 including vacuum nozzles 28 and a blower 30 are shown. Containment of the talc dust is preferred for environmental reasons as well as for equipment protection. In a particularly preferred embodiment, a tack-free formulation is provided which does not require applying talc 20 or other powdery release agent to the calendered web 22.

After optionally applying talc 20 to the surfaces of the web 22, the calendered web 32 is cured, preferably by cross-linking elastomeric components in the web 32 by exposing the web to actinic radiation. A preferred cross-linking or curing operation is by means of electron beam (EB) curing. Thus, in the preferred embodiment, the calendered web 32 is fed to an electron beam processor 34 for curing and cross-linking the elastomeric components of the web 32. EB curing of the web 32 may be conducted at a speed ranging from about 40 to about 100 feet per minute or more using an electron beam energy of 800 KeV and a beam current of 50 mA. The preferred electron beam dosage applied to the web 32 preferably ranges from about 12 to about 28 Mrad which is substantially higher than the dosage applied in a conventional low-dosage EB sterilization process. By “low dosage” it is meant exposure of the web to an EB in the range of about 2 to about 4 mA. Such low dosage EB sterilization does not provide significant reduction in the bio-burden as compared to the reduction in bio-burden achieved by the invention without prolonged exposure of the web to the low dosage EB radiation.

An important benefit of electron beam curing of the elastomeric bandage material with an EB dosage in the above ranges is that bio-burden of the cured web 36 is significantly reduced simultaneously with the curing process. Such simultaneous sterilization of webs is not provided to the same degree by conventional vulcanization curing processes. Webs cured by conventional vulcanization processes may require a cobalt 60 radiation pre-treatment after curing to reduce the bio-burden to acceptable levels. Such cobalt 60 radiation pre-treatment processes are typically conducted on a batch basis and thus are time consuming and less efficient than a procedure such as EB curing which can be conducted on a moving web. Accordingly, pre-treatment sterilization of the cured web 36 made according to the invention may be substantially eliminated.

Another benefit of electron beam curing, according to the invention, is that the web 32 may be cured in a continuous process whereas sulfur vulcanized webs are typically cured in a batch process. A continuous curing process for the web 32 provides improved manufacturing efficiency and thus lower manufacturing costs associated with producing sterilized elastic bandages.

Yet another unexpected benefit of the invention is that release agent coated webs 32 cured by an EB curing process exhibit reduced dusting properties when handled. While not desiring to be bound by theory, it is believed that a portion of the talc coating on the web surfaces prior to EB curing may be bound to the web by the curing process.

Subsequent to curing, the cured web 36 may again be dusted and/or vacuumed to remove any loose release agent and may be rolled on a roll 38 for shipping to a slitting and finishing device 40, or the cured web 36 may be fed directly to the slitting and finishing device 40. The slitting and finishing device 40 is configured to slit the cured web 36 in elongate sections having widths of preferably 3, 4 and 6 inches or more and lengths of from about 5 to about 15 feet to provide elastic bandages 42. The elastic bandages preferably have a thickness ranging from about 10 to about 25 mils. Elastic tourniquets may also be made from the cured webs. Tourniquets typically have a width of about 0.5 to 1.5 inches, lengths ranging from about 15 to about 25 inches long and have a thickness ranging from about 20 to about 30 mils. The elastic bandages and/or tourniquets may then be packaged for shipping and a final sterilization process. Final sterilization with, for example, ethylene oxide, is typically required where the manufacturing and packaging processes for the bandages are conducted in a non-sterile environment, such as a clean room. Because the bandages 42 made according to the invention are not tacky, no release paper is required for rolling of packaging the cured web 36 or bandages 42.

Other aspects of the invention are provided by the following non-limiting example.

### EXAMPLE 1

In this example, an electron beam curable elastic bandage formulation was used.

The formulation was compounded by conventional rubber compounding procedures as described above by first adding the rubber components to a water-cooled Number 11 Banbury mixer, adding the powdery components to the mixer, i.e., the pigments, inorganic filler compounds, antioxidants, and re-odorizing agents after about one minute of mixing, then adding the processing oil after about five minutes of mixing. As described above, the styrene-butadiene rubber (SBR) copolymer was pre-masticated in the Banbury mixer for about 15 minutes at a temperature ranging from about 290° to about 350° F. The total formulation was mixed in the Banbury mixer for nine minutes at a temperature ranging from about 280° to about 330° F.

TABLE 1
Electron Beam Cured Elastic Bandage Formulation

| | pounds per hundred | Weight |
|---|---|---|
| Ingredient | rubber (phr) | Percent |
| NATSYN 2205 | 80 | 52.93 |
| SBR 1502 | 20 | 13.23 |
| AKROSPERSE 414 | 0.05 | 0.03 |
| AKROSPERSE E- | 1.0 | 0.66 |
| 18016 | | |
| STANWHITE UF-1 | 42 | 27.79 |
| STAN-MASK 25243 | 0.1 | 0.07 |
| WINGSTAYL | 1.0 | 0.66 |
| SUNPAR 150 | 2.0 | 1.32 |
| HI-SIL WB 10 | 5.0 | 3.31 |

Electron beam cured elastic bandages made using the above formulation were tested to provide physical properties thereof. The samples tested were 1 inch by 4 inch pieces using a 1 inch benchmark and a separation speed of 20 inches per minute. The properties of samples were measured in the machine direction and the cross-machine direction. Average properties of the samples are contained in the following table.

TABLE 2
Elastic Bandage Physical Properties

| | | | Cross- | Cross- |
|---|---|---|---|---|
| Physical | Machine | Machine | Machine | Machine |
| Properties | Direction | Direction | Direction | Direction |
| | Example 1 | Commercial | Example 1 | Commercial |
| | | Bandage | | Bandage |
| thickness (inch) | 0.016 | 0.015 | 0.016 | 0.015 |
| Tensile | 502 | 2546 | 389 | 2301 |
| strength at | | | | |
| break (psi) | | | | |
| Elongation (%) | 723 | 1417 | 1076 | 1448 |
| Modulus at 200 | 137 | 147 | 55 | 136 |
| % elongation | | | | |
| (psi) | | | | |
| Modulus at 300 | 204 | 186 | 70 | 173 |
| % elongation | | | | |
| (psi) | | | | |

As shown by the foregoing table, elastic bandages made according to the invention exhibit significant elastic properties for use in many applications and may be used as a replacement for commercially available elastic bandages. Optimization of the formulation may provide closer comparison of the physical properties of the bandages made according to the invention, however, the physical properties provided above are in acceptable ranges.

It is contemplated, and will be apparent to those skilled in the art from the preceding description and the accompanying drawings, that modifications and changes may be made in the embodiments of the invention. Accordingly, it is expressly intended that the foregoing description and the accompanying drawings are illustrative of preferred embodiments only, not limiting thereto, and that the true spirit and scope of the present invention be determined by reference to the appended claims

1. A process for making an essentially natural rubber latex-free elastic compression bandage comprising, providing a homogeneous mixture containing from about 10 to about 70 percent by weight synthetic natural rubber, from about 5 to about 60 percent by weight secondary elastomeric compound, from about 15 to about 35 percent by weight inorganic fillers, and processing aids, feeding the homogeneous mixture to an extruder to provide an extruded web, calendering the extruded web to provide a calendered web, and electron beam curing the calendered web to provide an elastic web having a reduced bio-burden, wherein the percentages by weight of the mixture or based on the total weight of the mixture.

2. The process of claim 1 further comprising dusting the calendered web with hydrous magnesium silicate prior to curing the web to provide a tack-free calendered web.

3. The process of claim 2 further comprising removing excess hydrous magnesium silicate from the calendered web before and after curing the web.

4. The process of claim 1 further comprising slitting the elastic web to provide compression bandages.

5. The process of claim 1 wherein the synthetic natural rubber comprises synthetic polyisoprene.

6. The process of claim 1 wherein the secondary elastomeric compound comprises styrene-butadiene rubber block copolymer.

7. The process of claim 6 wherein the secondary elastomeric compound is pre-masticated in a masterbatch prior to mixing the secondary elastomeric compound with the synthetic natural rubber.

8. An elastic compression bandage having a reduced bio-burden made by the method of claim 1.

9. A natural rubber latex-free elastic bandage or band comprising an electron beam cured mixture containing from about 20 to about 90 parts by weight synthetic natural rubber, from about 10 to about 80 parts by weight secondary elastomeric compound, inorganic fillers and processing aids, wherein the bandage or band exhibits a bio-burden level which is achievable only by prolonged sterilization techniques.

10. The bandage or band of claim 9 further comprising a dusting containing hydrous magnesium silicate.

11. The bandage or band of claim 9 wherein the synthetic natural rubber comprises synthetic polyisoprene.

12. The bandage or band of claim 9 wherein the secondary elastomeric compound comprises styrene-butadiene rubber block copolymer.

13. The bandage or band of claim 9 wherein the inorganic fillers are selected from the group consisting of silicon dioxide, carbonates and silicates of magnesium, calcium, aluminum and zinc, and mixtures thereof.

14. The bandage or band of claim 9 wherein the inorganic filler comprises a mixture of calcium carbonate and precipitated silicon dioxide.
